(19) United States
(12) Patent Application Publication
(10) Pub. No.: US 2006/0124594 A1
(43) Pub. Date: Jun. 15, 2006

(54) Chemical mechanical polishing (CMP) slurries and CMP methods using and making the same

(76) Inventors: Jong-heun Lim, Seoul (KR); Jae-dong Lee, Suwon-si (KR); Bo-un Yoon, Seoul (KR); Chang-ki Hong, Seongnam-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/287,361

(22) Filed: Nov. 28, 2005

(30) Foreign Application Priority Data
Dec. 9, 2004 (KR) 10-2004-0103634

(51) Int. Cl. C09K 3/14; C09G 1/02; C09K 13/00; B44C 1/22; C23F 1/00; C09C 1/68; B24D 3/02

(52) U.S. Cl. 216/88; 51/307; 51/308; 51/309; 106/3; 216/89; 252/79.1

(57) ABSTRACT

In one aspect, a chemical-mechanical-polishing (CMP) slurry composition is provided which includes ceria abrasive contained in a solution, where the solution includes a viscosity increasing agent which includes a non-ionic polymer compound, and where a viscosity of the composition is at least 1.5 cP. In other aspects, the viscosity increasing agent includes one or more of poly(ethyleneglycol), a Gum compound and isopropyl alcohol.

### BACKGROUND OF THE INVENTION

1. Field of the Invention

The present invention generally relates to the fabrication of semiconductor devices, and more particularly, the present invention relates to chemical mechanical polishing (CMP) slurries and to CMP methods using the same.

2. Description of the Related Art

Semiconductor devices are comprised of numerous integrated circuits, which are produced by selectively and repeatedly performing a series of photographic, etching, diffusive, metal deposition, and other process steps. Further, efforts to achieve highly integrated semiconductor devices are typically attended by the stacking of multiple interconnection and other layers on a semiconductor wafer. The resultant unevenness of the wafer surface presents a variety of problems which are well-documented in the art. Planarization processes are thus adopted at various stages of fabrication in an effort to minimize irregularities in the wafer surface.

One such planarization technique is chemical/mechanical polishing (CMP). CMP is typically used for horizontally planarizing various kinds of layers, such as oxide layers, nitride layers, metal layers and the like, which are sequentially deposited on the semiconductor wafer to form the integrated circuits. As the integration degree of microelectronic devices continues to increase, CMP characteristics used in the fabrication of such devices become more and more critical.

A typical CMP apparatus includes a polishing table used for supporting and rotating a CMP pad positioned on the table. A wafer confronting the pad is fixed and rotated by a carrier positioned above the table, and the carrier moves vertically to selectively contact the wafer and the CMP pad at a designated pressure. The CMP pad is also rotated at the same time by the polishing table. A CMP slurry, which comprises a mixture of predetermined types of chemicals and other ingredients, is usually provided at the central point of the CMP pad, and is then evenly distributed and coated on the upper surface of the CMP pad by the rotating force of the CMP pad. The semiconductor wafer attached to the wafer carrier selectively contacts the slurry covered CMP pad to carry out the CMP process.

As a result of the relative rotation between the wafer and the CMP pad, and the slurry mixture on the surface of the CMP pad, both mechanical friction and chemical reactions take place, and the material comprising the layer to be polished is gradually removed from the surface of the wafer. More specifically, the mechanical removing action is performed by abrasive particles within the polishing slurry and surface bosses of the pad, and a chemical removing action is performed by one or more chemical ingredients within the polishing slurry. As a result, a wafer is said to be planarized to a certain pre-set thickness on the surface of the wafer.

It is well known that the ultimate quality of the polished state of a wafer depends on several factors, including, among others: (i) the mechanical friction between the CMP pad and the wafer, (ii) the material and state of the CMP pad, (iii) the evenness or uniformity of the surface of the CMP pad, (iv) the distribution rate of the CMP slurry, and (v) the composition of the CMP slurry. This disclosure is primarily directed to the composition and characteristics of the CMP slurry.

One exemplary and common application of CMP is in shallow trench isolation (STI). In STI techniques, relatively shallow isolation trenches are formed, which function as field regions used to separate active regions on a wafer.

A conventional example of an STI process is explained next with reference to the cross-sectional views of FIGS. 1A-1D. A pad oxide layer 102 and a silicon nitride (SiN) stop layer 104 are sequentially stacked on a semiconductor substrate 100. Thereafter, a photoresist pattern (not shown) is formed atop the SiN stop layer 104. Then, using the photoresist as a mask, the SiN stop layer 104, pad oxide layer 102 and the semiconductor substrate 100 are partially etched to form a plurality of trenches 106 as shown in FIG. 1A. Subsequently, as shown in FIG. 1B, an insulating oxide (SO₂) layer 108 (which will ultimately form the trench oxide regions) is deposited so as to fill the trenches 106 and cover the surface of the SiN stop layer 104. The oxide layer 108 is then subjected to CMP so as to remove the oxide layer 108 down to the level of the SiN stop layer 104. As a result, the configuration of FIG. 1C is obtained. The SiN stop layer 104 and the pad oxide layer 102 on the active regions are then removed via an etching process. Thereafter, a gate oxide layer 110 is formed on the surface of the semiconductor substrate 100 as shown in FIG. 1D.

During the above-mentioned CMP process, the oxide layer 108 is removed until the upper surface of the SiN stop layer 104 is exposed. Due to differing chemical and physical characteristics thereof, the oxide and SiN layers exhibit different removal rates when subjected to CMP using known slurries. The ratio of these removal rates at least partially defines the “selectivity” of the slurry being used. The lower the selectivity of the slurry, the more SiN that will be polished away during the CMP process.

In the meantime, the abrasive particles contained in most CMP slurries are either ceria-based particles of cerium oxide or silica-based particles of silicon dioxide. Each has advantages and disadvantages relative to the other. Table A below comparatively illustrates exemplary characteristics of ceria-based and silica-based slurries.

TABLE A

| | | Ceria slurry | Silica slurry |
|---|---|---|---|
| Abrasive | | CeO₂(Cerium Oxide) | SiO₂(Silicon Oxide) |
| Removal rate | SiO₂ | About 3,000 Å/min | About 3,000 Å/min |
| | SiN | Less than 100 Å/min | About 800 Å/min |

| | | |
|---|---|---|
| Cost | Relatively high | Relatively low |
| Favorable Property | High selectivity | Good uniformity |

As shown in Table A, the SiO₂ removal rates of ceria-based and silica-based slurries are similar, i.e., about 3000 Å per minute. On the other hand, the SiN removal rate (about 800 Å per minute) of the silica-based slurry is substantially larger than that (about 100 Å per minute) of the ceria-based slurry. Thus, the selectivity (about 30 to 1) of the ceria-based slurry is much higher than that (about 4 to 1) of the silica-based slurry. As such, excess removal of the silicon nitride stop layer during CMP is more likely when using a silica-based slurry. In this respect, ceria-based slurries are considered superior to silica-based slurries in terms of oxide-to-nitride selectivity.

However, silica-based slurries offer certain advantages over ceria-based slurries. One advantage is that ceria-based slurries tend to be less expensive. Another advantage is that the use silica-based slurries during CMP results in better uniformity of the planarized layer thickness across the surface of the wafer. The high uniformity of the silica-based slurry relative to the ceria-based slurry is described below with reference to FIGS. 2, 3 and 4.

FIG. 2 is a graph depicting CMP removal rates (RR) of an oxide film (plasma-enhanced tetra-ethyl-ortho-silicate (PETEOS)) at given radii of a wafer for each of silica-based and ceria based slurries. In the figure, the wafer has a normalized radius of 100. As can be seen in FIG. 2, the silica-based slurry exhibits a relative uniform removal rate (about 3000 Å/min) along most of the radius of the wafer. In contrast, the ceria-based slurry varies substantially along the wafer radius. More specifically, in this example, the removal rate of the ceria-based slurry is over 4000 Å/min near the center of the wafer, and gradually decreases to around 3000 Å/min towards the periphery of the wafer. As such, in the case of ceria-based slurries, more oxide material is removed during CMP at the center of the wafer than at its periphery. This “within-wafer non-uniformity” of the oxide thickness can cause device failures and/or local defocusing during subsequent lithography processes, which in turn can cause patterning errors and reduce process margins.

The non-uniform removal rate of ceria-based slurries is also evident during CMP of an STI patterned wafer. FIGS. 3 and 4 are plots of measured SiN layer thicknesses at different wafer radii for each of a plurality of CMP operations. Each of the wafers utilized in the measurements of FIG. 3 contained a continuous layer of SiN which was subjected to CMP. As shown, the average measured SiN thickness near the center of the wafer was about 10 Å less than the average measure thickness near the periphery of the wafer. In contrast, each of the wafers utilized in the measurements of FIG. 4 contained an STI patterned layer (see previously discussed FIGS. 1B and 1C). As shown, the average measured SiN thickness near the center of the wafer was about 23 Å less than the average measure thickness near the periphery of the wafer. Thus, it can be seen that there is greater SiN layer non-uniformity when using a ceria-based CMP slurry on an STI patterned wafer than when using a ceria-based CMP slurry on a wafer having a single layer of SiN.

To summarize, conventional ceria-based CMP slurries suffer a drawback in that they generally exhibit non-uniform CMP characteristics over the surface of the wafer. This problem is especially prevalent with respect to CMP of oxide layers and STI patterned layers.

### SUMMARY OF THE INVENTION

According to one aspect of the present invention, a chemical-mechanical-polishing (CMP) slurry composition is provided which includes ceria abrasive contained in a solution, where the solution includes a viscosity increasing agent which includes a non-ionic polymer compound, and where a viscosity of the composition is at least 1.5 cP.

According to another aspect of the present invention, a CMP slurry composition is provided which includes ceria abrasive contained in a solution, where the solution includes poly(ethyleneglycol) (PEG), and where the amount of PEG is 0.01 wt % to 5 wt % of the composition.

According to still another aspect of the present invention, a CMP slurry composition is provided which includes ceria abrasive suspended in a solution, where the solution includes a gum compound, and where the amount of the gum compound is 0.01 wt % to 5 wt % of the composition.

According to yet another aspect of the present invention, a CMP slurry composition is provided which includes ceria abrasive suspended in a solution, where the solution includes isopropyl alcohol (IPA), and where the amount of IPA is 0.01 wt % to 10 wt % of the composition.

According to another aspect of the present invention, a chemical-mechanical-polishing (CMP) slurry composition is provided which includes ceria abrasive suspended in a solution, where the solution includes a viscosity increasing agent which is a non-ionic polymeric compound, and where the amount of the viscosity increasing agent is 0.01 wt % to 10 wt % of the composition.

According to still another aspect of the present invention, a CMP method is provided which includes providing a CMP slurry composition which includes ceria abrasive contained in a solution. The solution includes a viscosity increasing agent which includes a non-ionic polymeric compound, and a viscosity of the CMP slurry composition is at least 1.5 cP. The method further includes moving a polishing pad relative to and against the surface of a substrate with the CMP slurry composition interposed between the polishing pad and the surface of the substrate.

According to another aspect of the present invention, a method of preparing a chemical-mechanical-polishing (CMP) slurry is provided which includes providing a CMP slurry composition which includes ceria abrasive contained in a solution, where a viscosity of the CMP slurry composition is less than about 1.3 cP, and admixing a viscosity increasing agent including a non-ionic polymeric compound into the CMP slurry composition to increase the viscosity of the CMP slurry composition to at least 1.5 cP.

### BRIEF DESCRIPTION OF THE DRAWINGS

The above and other aspects and features of the present invention will become readily apparent from the detailed description that follows, with reference to the accompanying drawings, in which:

FIGS. 1A through 1D are schematic cross-sectional views of wafer layers for use in explaining the formation of shallow trench isolation (STI) regions;

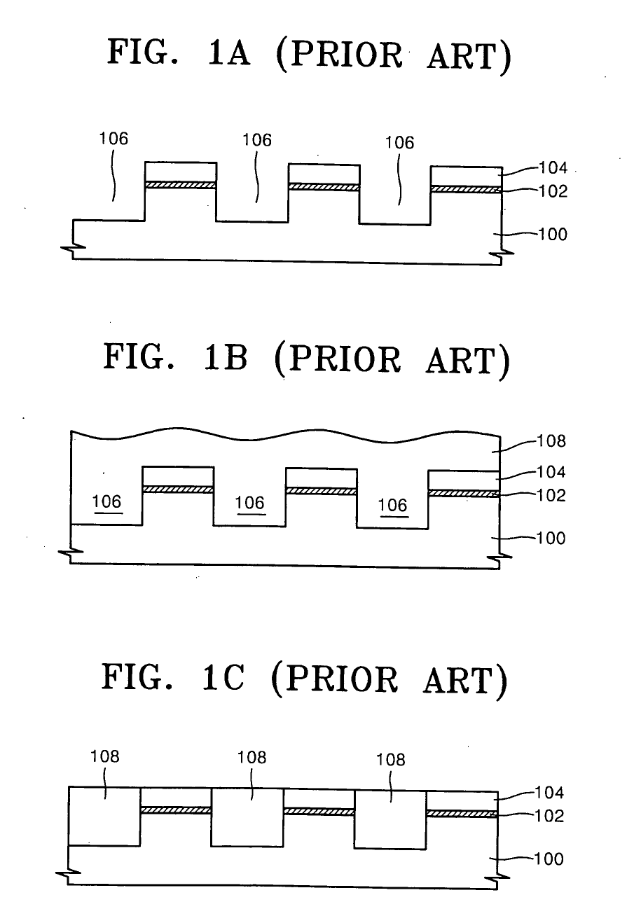

FIG. 2 is a graph illustrating conventional oxide layer removal rates of silica-based and ceria-based slurries relative the radius of a wafer surface;

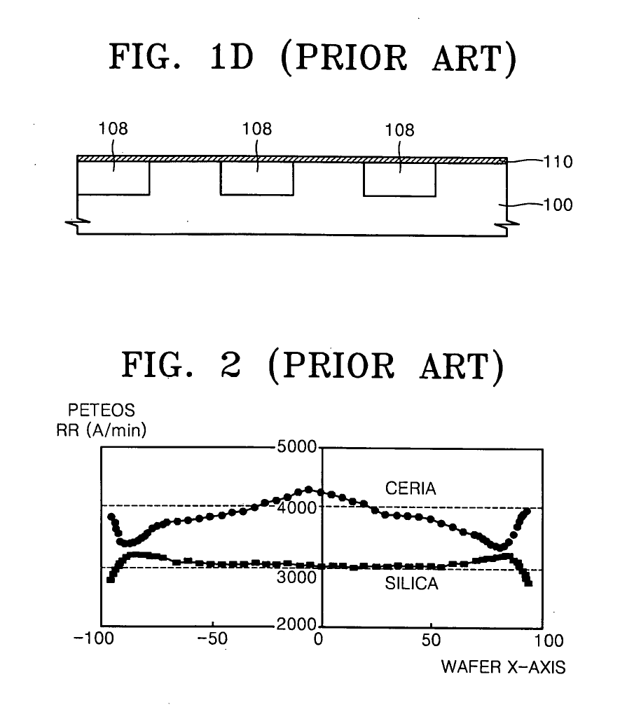

FIG. 3 is a plot of measured SiN layer thicknesses of a continuous SiN layer at different wafer radii for each of a plurality of CMP operations;

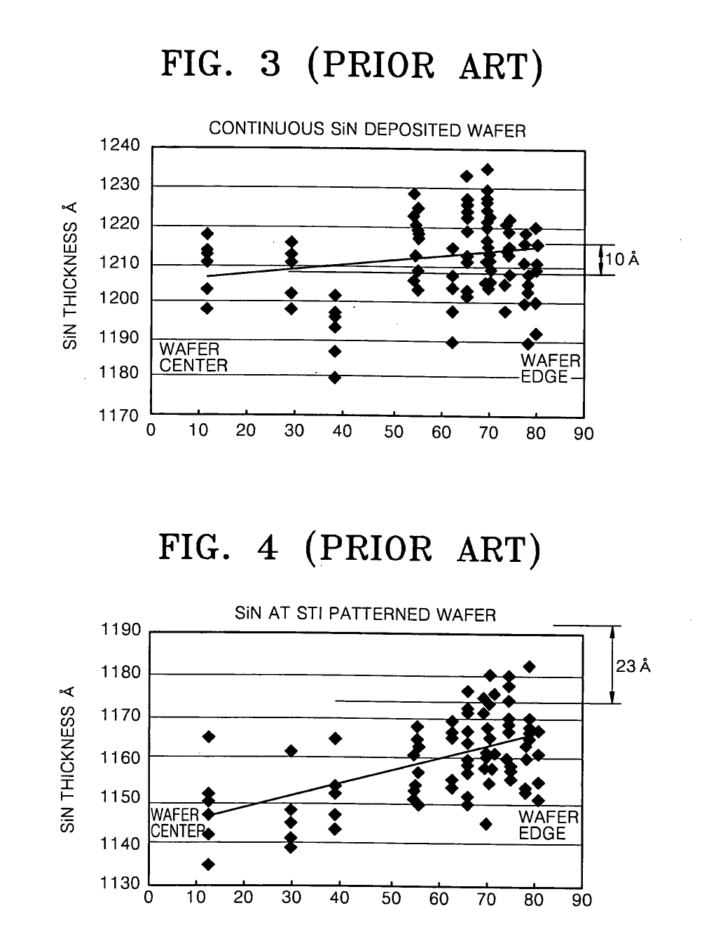

FIG. 4 is a plot of measured SiN layer thicknesses of an STI patterned layer at different wafer radii for each of a plurality of CMP operations;

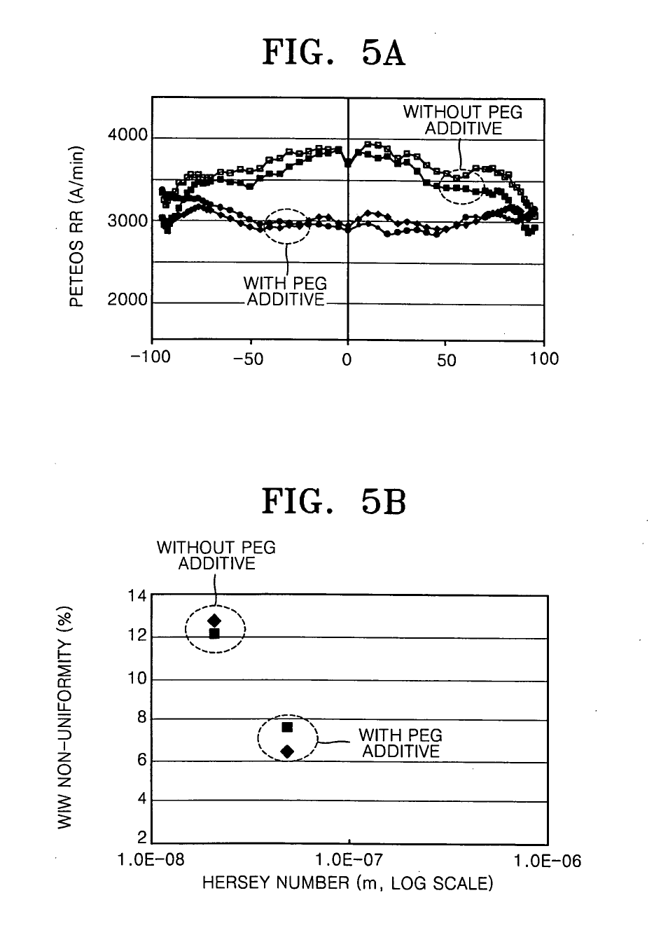

FIGS. 5A, 6A and 7A are graphs illustrating a comparison between the removal rates of conventional ceria-based slurries and the removal rates of ceria-based slurries of embodiments of the present invention; and

FIGS. 5B, 6B and 7B are graphs illustrating comparisons between within-wafer non-uniformity and Hersey Number of conventional ceria-based slurries and between within-wafer non-uniformity and Hersey Number of ceria-based slurries of embodiments of the present invention.

### DETAILED DESCRIPTION OF PREFERRED EMBODIMENTS

Certain aspects of the present invention at least partially result from the discovery that the inclusion a viscosity increasing agent of non-ionic polymer compound in a ceria-based CMP slurry can substantially improve the removal rate uniformity of the slurry. Without being limited by theory, it is presumed that the enhanced viscosity increases the thickness of the slurry between the pad and wafer, and that the increased thickness improves the removal rate uniformity during CMP.

It is known that slurry film thickness correlates with a so-called “Hersey Number” (H), where H=μV/Pc. In this equation, μ is the slurry viscosity, V is the relative velocity between the wafer and the polishing pad, and P_{C} is the contact pressure. Thus, it follows that increasing the viscosity μ will proportionally increase the Hersey Number (H), which will in turn result in an increased slurry thickness during CMP.

Conventional ceria-based slurries have a viscosity in the range of about 1.0 cP to about 1.3 cP. In the exemplary embodiments of the present invention, the viscosity of the ceria-based slurry is preferably in range of 1.5 cP to 5.0 cP, and more preferably in a range of 1.6 cP to 2.5 cP.

The present invention will now be described in detail with reference to preferred, but non-limiting, embodiments of the invention.

In an embodiment of the present invention, the non-ionic polymer compound used to increase viscosity is poly(ethyleneglycol) (PEG). PEG may be characterized by the following polymeric structure:

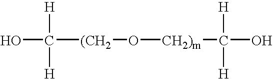

The molecular weight of the PEG is preferably in the range of 10,000 to 1,000,000, and more preferably in the range of 100,000 to 1,000,000. Also, the amount of PEG in the ceria-based slurry composition is preferably 0.01 wt % to 5 wt % of the composition.

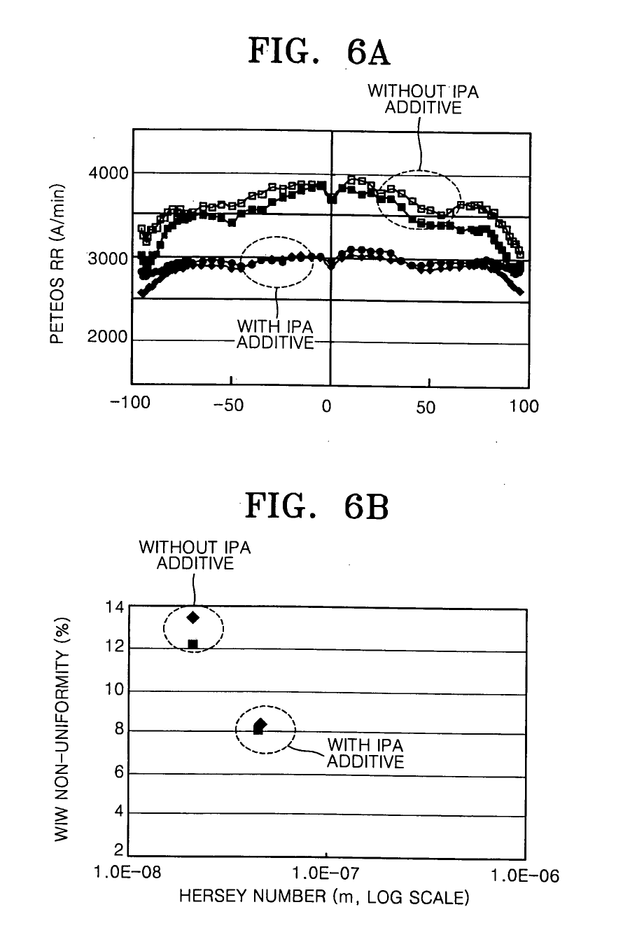

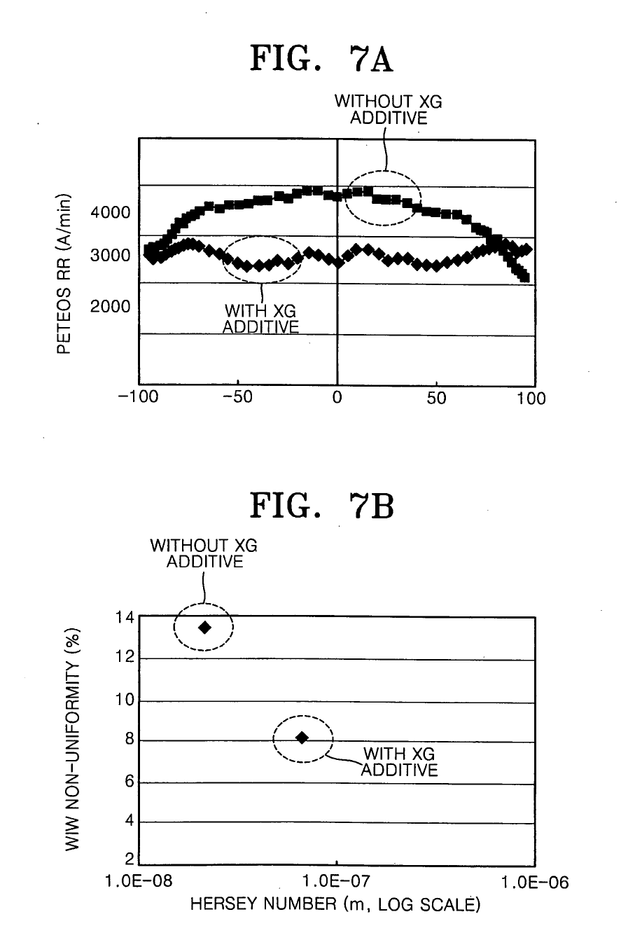

Attention is directed to FIG. 5A which is a graph illustrating PETEOS (oxide) removal rates of ceria-based CMP slurries with and without the viscosity increasing PEG additive. The top two lines of FIG. 5A represent results from experimental measurements using conventional ceria-based CMP slurries. The bottom two lines of FIG. 5A represent results from experimental measurements in which roughly 0.1% of PEG was added to the conventional ceria-based CMP slurry. As is readily apparent from these measurements, the inclusion of PEG into the ceria-based CMP slurry substantially improved the removal rate uniformity across the radius of the wafer.

FIG. 5B shows the relationship between Hersey Number and within-wafer (WIW) non-uniformity resulting from the same measurements used in FIG. 5A. It can be seen that the inclusion of PEG had the dual effects of increasing the Hersey Number of the CMP process, and improving the WIW non-uniformity of the CMP process across the surface of the wafer.

Table B below illustrates the results of oxide and SiN CMP experiments for each of varying amounts of PEG additive. In each case, a CMP apparatus designated MIRRA 3400 (made by Applied Materials Inc.) was used. In Table B, the “normal” ceria-based slurry composition was prepared by mixing a ceria grain agent HS-8005 (made by Hitachi Chemical Co. Ltd.), distilled water (DI) and an additive HS-8102GP (made by Hitachi Chemical Co. Ltd.) in respective proportions of 1:3:3. Differing amounts of PEG (having a molecular weight of 500,000) were added to the normal ceria-based slurry composition to obtain the remaining compositions of Table B.

TABLE B

| | Ceria | Ceria | Ceria | Ceria |
|---|---|---|---|---|
| | Normal | PEG 0.05% | PEG 0.1% | PEG 0.2% |
| | (HS 1: DI 3: | (HS 1: DI 3: | (HS 1: DI 3: | (HS 1: DI 3: |
| Slurry | GP 3) | GP 3) | GP 3) | GP 3) |
| Viscosity | 1.3 cP | 1.6 cP | 1.8 cP | 2.4 cP |
| oxide | 3,496 | 3,045 | 3,096 | 3,089 |
| RR(Å/min) | | | | |
| WIWNU | 9.8% | 3.8% | 3.7% | 3.2% |
| SiN | 87 | 89 | 88 | 91 |
| RR(Å/min) | | | | |
| Selectivity | 40.2 | 34.2 | 35.2 | 34.0 |

As shown in Table B, the addition of 0.05% wt of PEG to the ceria-based slurry composition increased the viscosity from about 1.3 cP to about 1.6 cP, and improved within-wafer non-uniformity (WIWNU) from about 9.8% to about 3.8%. 0.1% wt of PEG further increased viscosity to about 1.8 cP and reduced WIWNU to about 3.7%. 0.2% wt of PEG even further increased viscosity to about 2.4 cP and reduced WIWNU to 3.2%.

Of additional note in Table B is the lack of significant effect of the PEG additive on the removal rate (RR) of SiN. As shown, the SiN removal rate remained fairly constant (about 87-89 Å/min.) as the PEG content was varied. The oxide removal rate, however, was decreased with an increase in PEG content, and the selectivity was thus reduced as shown in Table B.

In another embodiment of the present invention, the non-ionic polymer compound used to increase viscosity includes isopropyl alcohol (IPA). IPA may be structurally identified as follows:

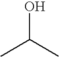

The amount of IPA in the ceria-based slurry composition is preferably 0.01 wt % to 10 wt % of the composition.

Attention is directed to FIG. 6A which is a graph illustrating PETEOS (oxide) removal rates of ceria-based CMP slurries with and without the viscosity increasing IPA additive. The top two lines of FIG. 6A represent results from experimental measurements using conventional ceria-based CMP slurries. The bottom two lines of FIG. 6A represent results from experimental measurements in which roughly 0.05% of IPA was added to the conventional ceria-based CMP slurry. As is readily apparent from these measurements, the inclusion of IPA into the ceria-based CMP slurry substantially improved the removal rate uniformity across the radius of the wafer.

FIG. 6B shows the relationship between Hersey Number and within-wafer (WIW) non-uniformity resulting from the same measurements used in FIG. 6A. It can be seen that the inclusion of IPA increase the Hersey Number of the CMP process, and improved the WIW non-uniformity of the CMP process across the surface of the wafer.

Table C below illustrates the results of oxide removal CMP experiments for ceria-based CMP slurries with and without the IPA additive. A CMP apparatus designated MIRRA 3400 (made by Applied Materials Inc.) was used, and the “normal” ceria-based slurry composition of Table C was prepared by mixing a ceria grain agent HS-8005 (made by Hitachi Chemical Co. Ltd.), distilled water (DI) and an additive HS-8102GP (made by Hitachi Chemical Co. Ltd.) in respective proportions of 1:3:3. The second composition of Table C was prepared by adding 0.05% wt of IPA to the normal ceria-based slurry composition.

TABLE C

| | Ceria Normal | Ceria IPA 0.05% |
|---|---|---|
| | (HS 1: DI 3: GP 3) | (HS 1: DI 3: GP 3) |
| Viscosity | 1.3 cP | 2.0 cP |
| oxide RR (Å/min) | 3,496 | 2,544 |
| WIWNU | 9.8% | 5.0% |

As shown in Table C, the addition of 0.05% wt of IPA to the ceria-based slurry composition increased the viscosity from about 1.3 cP to about 2.0 cP, decreased the oxide removal rate from about 3,496 Å/min to about 2,544 Å/min, and improved within-wafer non-uniformity (WIWNU) from about 9.8% to about 5.0%.

In still another embodiment of the present invention, the non-ionic polymer compound used to increase viscosity includes a gum compound, such as one or more of Xanthan Gum, Arabic Gum, Guaiac gum, Mastic Gum and Rosin Gum. The polymeric structure of Xanthan Gum ((C₃₅H₄₉O₂₉)ₙ), for example, may be represented as follows:

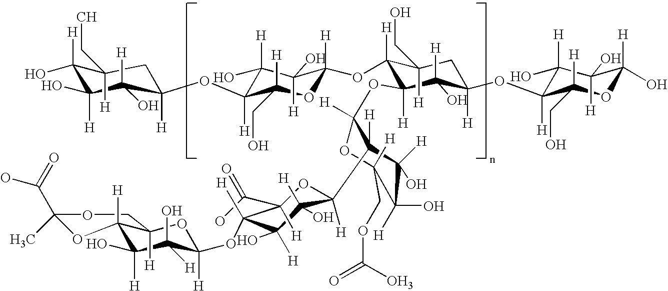

The amount of the gum compound in the ceria-based slurry composition is preferably 0.01 wt % to 10 wt % of the composition. Further, the molecular weight of the gum compound is preferably in the range of 100,000 to 10,000,000.

Attention is directed to FIG. 7A which is a graph illustrating PETEOS (oxide) removal rates of ceria-based CMP slurries with and without the viscosity increasing Xanthan Gum additive. The top line of FIG. 7A represent results from experimental measurements using conventional ceria-based CMP slurries. The bottom line of FIG. 7A represent results from experimental measurements in which roughly 0.05% of Xanthan Gum was added to the conventional ceria-based CMP slurry. As is readily apparent from these measurements, the inclusion of Xanthan Gum into the ceria-based CMP slurry substantially improved the removal rate uniformity across the radius of the wafer.

FIG. 7B shows the relationship between Hersey Number and removal rate non-uniformity resulting from the same measurements used in FIG. 7A. It can be seen that the inclusion of Xanthan Gum had the dual effects of increasing the Hersey Number of the CMP process, and improving the within-wafer (WIW) uniformity of the CMP process across the surface of the wafer.

Table D below illustrates the results of oxide removal CMP experiments for ceria-based CMP slurries with and without the Xanthan Gum additive. A CMP apparatus designated MIRRA 3400 (made by Applied Materials Inc.) was used, and the “normal” ceria-based slurry composition of Table C was prepared by mixing a ceria grain agent HS-8005 (made by Hitachi Chemical Co. Ltd.), distilled water (DI) and an additive HS-8102GP (made by Hitachi Chemical Co. Ltd.) in respective proportions of 1:3:3. The second composition of Table C was prepared by adding 0.05% wt of Xanthan Gum to the normal ceria-based slurry composition.

TABLE D

| | Ceria Normal | Ceria Xanthan 0.05% |
|---|---|---|
| | (HS 1: DI 3: GP 3) | (HS 1: DI 3: GP 3) |
| Viscosity | 1.3 cP | 2.0 cP |
| Oxide RR (Å/min) | 3,309 | 2,684 |
| WIWNU | 11.7% | 6.8% |

As shown in Table D, the addition of 0.05% wt of Xanthan Gum to the ceria-based slurry composition increased the viscosity from about 1.3 cP to about 2.0 cP, decreased the oxide removal rate from about 3,309 Å/min to about 2,684 Å/min, and improved within-wafer non-uniformity (WIWNU) from about 11.7% to about 6.8%.

As demonstrated above, the inclusion a viscosity increasing agent of non-ionic polymer compound in a ceria-based CMP slurry can substantially improve the removal rate uniformity when the slurry is used in during CMP to polish an oxide layer or an STI patterned layer of a wafer. This within-wafer non-uniformity of the polished layer is thus improved, thus minimizing device failures and local defocusing during subsequent lithography processes.

It is noted that the ceria-based slurry compositions of the present invention may include two or more different non-ionic polymer compounds. For example, the compositions may include two or more of PEG, IPA and a gum compound.

It is further noted that the ceria-based slurry compositions of the present invention may include, among other things, a surfactant which may have a composition which is different the composition of the viscosity increasing agent or agents.

Although the present invention has been described above in connection with the preferred embodiments thereof, the present invention is not so limited. Rather, various changes to and modifications of the preferred embodiments will become readily apparent to those of ordinary skill in the art. Accordingly, the present invention is not limited to the preferred embodiments described above. Rather, the true spirit and scope of the invention is defined by the accompanying claims.

What is claimed is:

1. A chemical-mechanical-polishing (CMP) slurry composition, comprising ceria abrasive contained in a solution, the solution comprising a viscosity increasing agent which includes a non-ionic polymer compound, wherein a viscosity of the composition is at least 1.5 cP.

2. The CMP slurry composition of claim 1, wherein the viscosity is at most 5.0 cP.

3. The CMP slurry composition of claim 1, wherein the viscosity is at least 1.6 cP.

4. The CMP slurry composition of claim 4, wherein the viscosity is at most 2.5 cP.

5. The CMP slurry composition of claim 1, wherein the viscosity increasing agent comprises poly(ethyleneglycol) (PEG).

6. The CMP slurry composition of claim 5, wherein a molecular weight of the PEG is in the range of 10,000 to 1,000,000.

7. The CMP slurry composition of claim 5, wherein a molecular weight of the PEG is in the range of 100,000 to 1,000,000.

8. The CMP slurry composition of claim 5, wherein the amount of PEG is 0.01 wt % to 5 wt % of the composition.

9. The CMP slurry composition of claim 1, wherein the viscosity increasing agent comprises a Gum compound.

10. The CMP slurry composition of claim 9, wherein the gum compound is at least one of Xanthan Gum, Arabic Gum, Guaiac gum, Mastic Gum and Rosin Gum.

11. The CMP slurry composition of claim 9, wherein the Gum compound is Xanthan Gum.

12. The CMP slurry composition of claim 9, wherein a molecular weight of the Gum compound is in the range of 100,000 to 10,000,000.

13. The CMP slurry composition of claim 9, wherein the amount of Gum compound is 0.01 wt % to 5 wt % of the composition.

14. The CMP slurry composition of claim 1, wherein the viscosity increasing agent comprises isopropyl alcohol (IPA).

15. The CMP slurry composition of claim 14, wherein the amount of IPA is 0.01 wt % to 10 wt % of the composition.

16. The CMP slurry composition of claim 1, wherein the viscosity increasing agent comprises at least two different nonionic polymeric compounds.

17. The CMP slurry composition of claim 1, wherein the viscosity increasing agent comprises at least two of poly(ethyleneglycol), a Gum compound and isopropyl alcohol.

18. The CMP slurry composition of claim 1, further comprising a surfactant having a composition which is different than a composition of the viscosity increasing agent.

19. A chemical-mechanical-polishing (CMP) slurry composition comprising ceria abrasive contained in a solution, the solution comprising poly(ethyleneglycol) (PEG), wherein the amount of PEG is 0.01 wt % to 5 wt % of the composition.

20. A chemical-mechanical-polishing (CMP) slurry composition comprising ceria abrasive suspended in a solution, the solution comprising a gum compound, wherein the amount of the gum compound is 0.01 wt % to 5 wt % of the composition.

21. The CMP slurry composition of claim 20, wherein the gum compound is at least one of Xanthan Gum, Arabic Gum, Guaiac gum, Mastic Gum and Rosin Gum.

22. The CMP slurry composition of claim 20, wherein the Gum compound is Xanthan Gum.

23. A chemical-mechanical-polishing (CMP) slurry composition comprising ceria abrasive suspended in a solution, the solution comprising isopropyl alcohol (IPA), wherein the amount of IPA is 0.01 wt % to 10 wt % of the composition.

24. A chemical-mechanical-polishing (CMP) slurry composition comprising ceria abrasive suspended in a solution, the solution comprising a viscosity increasing agent, wherein the viscosity increasing agent includes a non-ionic polymeric compound, and wherein the amount of the viscosity increasing agent is 0.01 wt % to 10 wt % of the composition.

25. The CMP slurry composition of claim 24, wherein the amount of the viscosity increasing agent is 0.01 wt % to 5 wt % of the composition.

26. The CMP slurry composition of claim 24, wherein the viscosity increasing agent comprises at least one of poly(ethyleneglycol), a Gum compound and isopropyl alcohol.

27. A chemical-mechanical-polishing (CMP) method, comprising:
providing a CMP slurry composition which comprises ceria abrasive contained in a solution, wherein the viscosity increasing agent comprises a non-ionic polymeric compound, and wherein a viscosity of the composition is at least 1.5 cP; and
moving a polishing pad relative to and against the surface of a substrate with the CMP slurry composition interposed between the polishing pad and the surface of the substrate.

28. The CMP method of claim 27, wherein the substrate is semiconductor wafer having oxide and nitride surface regions.

29. The CMP method of claim 28, wherein the oxide and nitride surface regions define a shallow trench isolation pattern of the wafer.

30. The CMP method of claim 27, wherein the substrate is a semiconductor wafer which is covered by an oxide layer.

31. The CMP method of claim 27, wherein the viscosity of the composition is at most 5.0 cP.

32. The CMP method of claim 27, wherein the viscosity of the composition is at least 1.6 cP.

33. The CMP method of claim 32, wherein the viscosity of the composition is at most 2.5 cP.

34. The CMP method of claim 27, wherein the viscosity increasing agent comprises poly(ethyleneglycol) (PEG).

35. The CMP method of claim 34, wherein a molecular weight of the PEG is in the range of 10,000 to 1,000,000.

36. The CMP method of claim 34, wherein a molecular weight of the PEG is in the range of 100,000 to 1,000,000.

37. The CMP method of claim 34, wherein the amount of PEG is 0.01 wt % to 5 wt % of the composition.

38. The CMP method of claim 27, wherein the viscosity increasing agent comprises a Gum compound.

39. The CMP method of claim 38, wherein the gum compound is at least one of Xanthan Gum, Arabic Gum, Guaiac gum, Mastic Gum and Rosin Gum.

40. The CMP method of claim 38, wherein the Gum compound is Xanthan Gum.

41. The CMP method of claim 38, wherein a molecular weight of the Gum compound is in the range of 100,000 to 10,000,000.

42. The CMP method of claim 38, wherein the amount of Gum compound is 0.01 wt % to 5 wt % of the composition.

43. The CMP method of claim 27, wherein the viscosity increasing agent comprises isopropyl alcohol (IPA).

44. The CMP method of claim 43, wherein the amount of IPA is 0.01 wt % to 10 wt % of the composition.

45. The CMP method of claim 27, wherein the viscosity increasing agent comprises at least two different nonionic polymeric compounds.

46. The CMP method of claim 27, wherein the viscosity increasing agent comprises at least two of poly(ethyleneglycol), a Gum compound and isopropyl alcohol.

47. The CMP method of claim 27, wherein the composition further comprises a surfactant having a composition which is different than a composition of the viscosity increasing agent.

48. A method of preparing a chemical-mechanical-polishing (CMP) slurry, comprising:
providing a CMP slurry composition which comprises ceria abrasive contained in a solution, wherein a viscosity of the CMP slurry composition is less than about 1.3 cP; and
admixing a viscosity increasing agent comprising a non-ionic polymeric compound into the CMP slurry composition to increase the viscosity of the CMP slurry composition to at least 1.5 cP.

49. The method of claim 48, wherein the viscosity increasing agent comprises poly(ethyleneglycol) (PEG).

50. The method of claim 49, wherein the amount of PEG admixed into the CMP slurry composition is 0.01 wt % to 5 wt % of the composition.

51. The method of claim 48, wherein the viscosity increasing agent comprises a Gum compound.

52. The method of claim 51, wherein the amount of Gum compound admixed into the CMP slurry composition is 0.01 wt % to 5 wt % of the composition.

53. The method of claim 48, wherein the viscosity increasing agent comprises isopropyl alcohol (IPA).

54. The CMP method of claim 53, wherein the amount of IPA admixed into the CMP slurry composition is 0.01 wt % to 10 wt % of the composition.
